(19) United States
(12) Patent Application Publication
(10) Pub. No.: US 2017/0293980 A1
(43) Pub. Date: Oct. 12, 2017

(54) SYSTEM AND METHOD FOR MANAGING PROCESSING RESOURCES OF A COMPUTING SYSTEM

(71) Applicant: Aon Securities, Inc., Chicago, IL (US)

(72) Inventors: Peter Phillips, Toronto (CA); Daniel Bogod, Chicago, IL (US); Aamir Mohammad, Chicago, IL (US)

(21) Appl. No.: 15/633,302

(22) Filed: Jun. 26, 2017

Related U.S. Application Data
(63) Continuation-in-part of application No. 15/058,117, filed on Mar. 1, 2016.
Application No. 15/058,117 is a continuation of application No. 13/079,637, filed on Apr. 4, 2011, now abandoned.

(51) Int. Cl. G06Q 40/08; H04L 29/08; G06Q 40/04

(52) U.S. Cl. CPC G06Q 40/08; G06Q 40/04; H04L 67/10; G06F 17/30516

(57) ABSTRACT

In illustrative embodiments, systems and methods for managing processing resources of a computing grid coordinate calculation of operations supporting real-time or near real-time risk hedging decisions. A data input interface transforms a received real-time data stream including real-time financial market data and trade updates for a user into a data structure format compatible with computing resources. Computing resources of a computing grid calculate variable annuity calculation results for allocated processing tasks associated with the received data stream. A task manager server divides the transformed data stream into processing tasks, controls allocation and deallocation of the processing tasks to the computing resources, and aggregates computation results into an output array representing evaluation results for the received data stream. A web server generates a seriatim intraday report from the computation results illustrating an effect on an intraday risk position based upon trade updates as evidenced by the evaluation results.

### CROSS-REFERENCE TO RELATED APPLICATIONS

This application is a continuation-in-part of and claims the benefit of priority from U.S. patent application Ser. No. 15/058,117, filed Mar. 1, 2016 entitled “System and Method for Managing Variable Annuity Hedging,” which is a continuation of U.S. patent application Ser. No. 13/079,637, filed Apr. 4, 2011. All above identified applications are hereby incorporated by reference in their entireties.

### BACKGROUND

The present disclosure generally relates to a system and method for an integrated, real time system to analyze, manage and report data for variable annuities and, more particularly, to hedge variable annuity risks.

Decisions involving insurance, financial, and other complex markets typically involve risk analysis. Transactions involving variable annuities are one type of financial product that is often analyzed for risk. A variable annuity is a contract offered by an insurance company that can be used to accumulate tax deferred savings. An initial premium is paid, but various fees are collected from among a number of subaccounts of the variable annuity over time. The purchaser's contract value, which fluctuates over time, reflects the performance of the underlying investments held by the allocation, minus the contract expenses, as well as any number of financial guarantees provided by purchase of the variable annuity as well as specific riders.

A variable annuity offers a range of investment options and the value of the investment will vary depending on the performance of the chosen investment options and aforementioned guaranteed values. The investment options for a variable annuity are typically made up of mutual funds. Variable annuities differ from mutual funds, however. Variable annuity holders can have embedded financial guarantees like guaranteed death benefit. For example, a beneficiary of a variable annuity with a guaranteed death benefit may receive guaranteed premium should the holder die before the insurer has started making payments even if their invested account value is below this amount due to subsequent market movements and account fees. Second, variable annuities are tax-deferred and holders pay no taxes on the income and investment gains from the variable annuity until the holder begins withdrawing. A typical Guaranteed Minimum Living Benefit” variable annuity rider might refer to Accumulation (GMAB), Income (GMIB), or Withdrawal (GMWB) financial guarantee.

A variable annuity typically has two phases: an accumulation phase and a payout phase. During the accumulation phase, a policyholder makes an initial payment and/or periodic payments that are allocated to a number of investment options. Once the variable annuity matures, at the beginning of the payout phase, a policyholder may elect to receive the value of the purchase payments plus investment income and gains (if any) as a lump-sum payment. Alternatively, a policyholder holder may choose to receive payout as a stream of payments at regular intervals.

For companies that offer variable annuities, reinsuring or hedging the guarantees offered by these variable annuity products often involves complex calculations that must consider a massive amount of market data to prevent potentially large losses. Variable annuity hedging that allows insurance companies to transfer the capital market risk (e.g., stock price fluctuations, market volatility, interest rate changes, etc.) involved with annuity guarantees to other parties. By hedging, the uncertain risk is transferred for a more certain set of cashflows by as hedge assets cashflows work to offset the changes in liability financial guarantee cashflows that are owed to the policyholder. The biggest difference between variable annuity policies and most common financial derivatives is the duration and complexity of the embedded financial guarantees. Not only must variable annuity managers account for market related financial risks, but they also have to do so in the presence of insurance related risks such as surrender, longevity and mortality risk. In this sense, variable annuities are complicated products to price, and even more complicated to hedge.

While it is impossible to exactly match the changes in the liability due to market fluctuations, techniques have been developed to better understand and analyze likely market scenarios to manage variable annuity allocation risks. For example, allocation and trading decisions are traditionally based on mathematical analyses of market data. After trading hours, the end-of-day market data and after-hours trading data is often analyzed to determine the allocation decisions for the next trading day.

The end-of-day market data may be analyzed using Monte Carlo or other simulations to formulate the next day's trading strategy. Briefly, a Monte Carlo simulation is a problem solving technique used to approximate the probability of certain outcomes by running multiple trial runs or simulations using random variables. Monte Carlo simulation is particularly useful for modeling financial and business risk in variable annuity contract allocation where there is significant uncertainty in inputs. Monte Carlo simulations compute a variety of common values used in mathematical finance such as quantities representing the sensitivities of the price of derivatives to a change in underlying parameters on which the value of an instrument or portfolio of financial instruments is dependent (e.g., risk sensitivities, risk measures, hedge parameters, etc.). Monte Carlo simulations in some financial areas require a significant amount of computing power and, thus, require a significant amount of time to compute.

One type of calculation used in Monte Carlo simulation is a set of calculations collectively known as “the Greeks.” In mathematical finance, the Greeks are quantities representing the sensitivities of derivative price (e.g., option price) to a change in underlying dependent parameters for the value of an instrument or portfolio of financial instruments. The Greeks may also be referred to as risk sensitivities, risk measures, or hedge parameters. Variable annuity portfolio managers may use the Greeks to measure the sensitivity of the value of a portfolio to a small change in a given underlying parameter. Using these measures, component risks may be treated in isolation and each variable annuity portfolio rebalanced to achieve desired exposure.

Because of time and computing technology constraints, the simulations necessary to create the next day's allocation and trading strategy are run after hours using end-of-day or older data. Thus, each day's trading strategy is based on data that is often many hours or even days old and does not account for market changes that occur on the same day as the data that was used to formulate the strategy.

### SUMMARY OF ILLUSTRATIVE EMBODIMENTS

The forgoing general description of the illustrative implementations and the following detailed description thereof are merely exemplary aspects of the teachings of this disclosure, and are not restrictive.

In certain embodiments, systems and methods for managing processing resources of a computing grid may coordinate calculation of operations supporting real-time or near real-time risk hedging decisions. A data input interface may transform a received real-time data stream including real-time financial market data and trade updates for a user into a data structure format compatible with computing resources. In some examples, computing resources of a high performance computing grid can calculate variable annuity calculation results for allocated processing tasks associated with the received data stream. A task manager server may divide the transformed data stream into processing tasks, control allocation and deallocation of the processing tasks to the computing resources, and aggregate computation results into an output array representing evaluation results for the received data stream. In certain embodiments, a web server may generate a seriatim intraday report from the computation results illustrating an effect on an intraday risk position based upon trade updates as evidenced by the evaluation results.

In certain embodiments, in response to receiving a transformed data stream, the task manager server may establish a first communication link with a computing core managing server that allocates processing tasks to the computing resources in response when commanded by the task managing server. The task manager server may initiate a data stream processing session with the computing core managing server via the first communication link that includes allocation commands for execution of processing tasks by the computing resources. In certain implementations, the task manager server may also establish a second communication link directly with the allocated computing resources. The processing tasks allocated to the computing resources may include a particular function of a set of functions for performing a Monte Carlo or other Greeks simulations.

In certain examples, the system may include a combination of cloud-based and non-cloud-based computing resources. In some implementations, balancing assignment of the processing tasks among the computing resources may be based on network connectivity conditions for communication links between the cloud-based and non-cloud-based computing resources.

In certain embodiments, aggregating the computation results for the processing tasks may include issuing aggregation commands to one or more allocated computing cores at predetermined checkpoints associated with interrelated computation results calculated by different computing resources. Aggregated computation results may be calculated from the interrelated computation results.

Benefits of the embodiments described herein include improved utilization of the computing resources of the system that allows variable annuity calculations to be performed in real time in response to receiving an incoming data stream that includes real-time financial market data and variable annuity portfolio data in addition to any models, assumptions, or limits that are used by the computing resources to execute the Monte Carlo simulations or other types of computations that may be used to develop future trading strategies. In certain embodiments, simultaneous allocation and deallocation of processing tasks to the various computing resources and load balancing between the computing resources may improve network performance and allows saturation conditions to be achieved at the computing resources without overtaxing just a few of the available computing resources.

### BRIEF DESCRIPTION OF THE DRAWINGS

The accompanying drawings, which are incorporated in and constitute a part of the specification, illustrate one or more embodiments and, together with the description, explain these embodiments. The accompanying drawings have not necessarily been drawn to scale. Any values dimensions illustrated in the accompanying graphs and figures are for illustration purposes only and may or may not represent actual or preferred values or dimensions. Where applicable, some or all features may not be illustrated to assist in the description of underlying features. In the drawings:

FIG. 1A illustrates a block diagram of an exemplary variable annuity hedging system in accordance with the described embodiments;

FIG. 1B illustrates a block diagram of a Data Input Interface Architecture for an exemplary variable annuity hedging system and method in accordance with the described embodiments;

FIG. 1C illustrates a block diagram of a primary and standby environment for a high-performance computing grid architecture on which the exemplary variable annuity hedging system and method may operate in accordance with the described embodiments;

FIG. 2 illustrates an exemplary block diagram of a computer/server component of an exemplary variable annuity hedging system and method in accordance with the described embodiments;

FIG. 3 illustrates an exemplary block diagram of a user device of an exemplary variable annuity hedging system and method in accordance with the described embodiments;

FIG. 4 illustrates an exemplary block diagram of a method for using the variable annuity hedging system in accordance with the described embodiments;

FIG. 5 illustrates another exemplary block diagram of a method for using the variable annuity hedging system in accordance with the described embodiments;

FIG. 6 illustrates still another exemplary block diagram of a method for using the variable annuity hedging system in accordance with the described embodiments;

FIG. 7 illustrates one example of a real-time report generated by the variable annuity hedging system;

FIGS. 8 and 9 illustrate examples of other reports generated by the variable annuity hedging system;

FIG. 10 illustrates a block diagram of a high performance computing grid architecture on which the exemplary variable annuity hedging system and method may operate in accordance with the described embodiments;

FIG. 11 illustrates a flow diagram of a method for managing a computing grid;

FIG. 12 illustrates a flow diagram of a method for processing resource allocation and deallocation; and

FIG. 13 illustrates a flow diagram of a method for GPUD task execution.

### DETAILED DESCRIPTION OF ILLUSTRATIVE EMBODIMENTS

The description set forth below in connection with the appended drawings is intended to be a description of various, illustrative embodiments of the disclosed subject matter. Specific features and functionalities are described in connection with each illustrative embodiment; however, it will be apparent to those skilled in the art that the disclosed embodiments may be practiced without each of those specific features and functionalities.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments. Further, it is intended that embodiments of the disclosed subject matter cover modifications and variations thereof.

It must be noted that, as used in the specification and the appended claims, the singular forms “a,” “an,” and “the” include plural referents unless the context expressly dictates otherwise. That is, unless expressly specified otherwise, as used herein the words “a,” “an,” “the,” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein merely describe points of reference and do not necessarily limit embodiments of the present disclosure to any particular orientation or configuration. Furthermore, terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

Furthermore, the terms “approximately,” “about,” “proximate,” “minor variation,” and similar terms generally refer to ranges that include the identified value within a margin of 20%, 10% or preferably 5% in certain embodiments, and any values therebetween.

All of the functionalities described in connection with one embodiment are intended to be applicable to the additional embodiments described below except where expressly stated or where the feature or function is incompatible with the additional embodiments. For example, where a given feature or function is expressly described in connection with one embodiment but not expressly mentioned in connection with an alternative embodiment, it should be understood that the inventors intend that that feature or function may be deployed, utilized or implemented in connection with the alternative embodiment unless the feature or function is incompatible with the alternative embodiment.

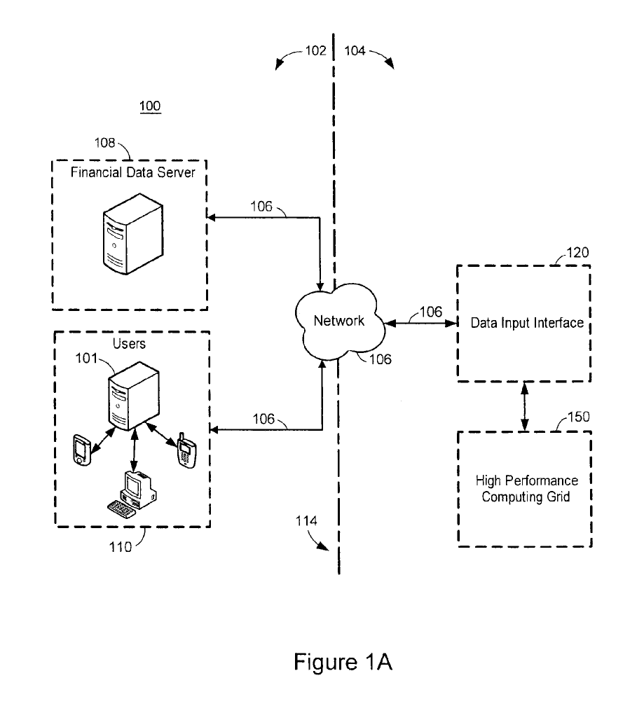

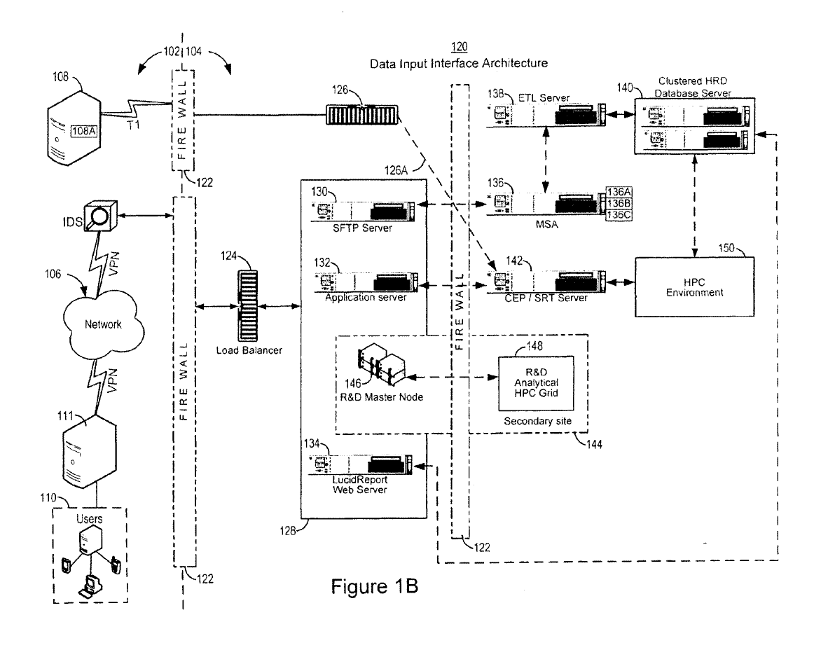

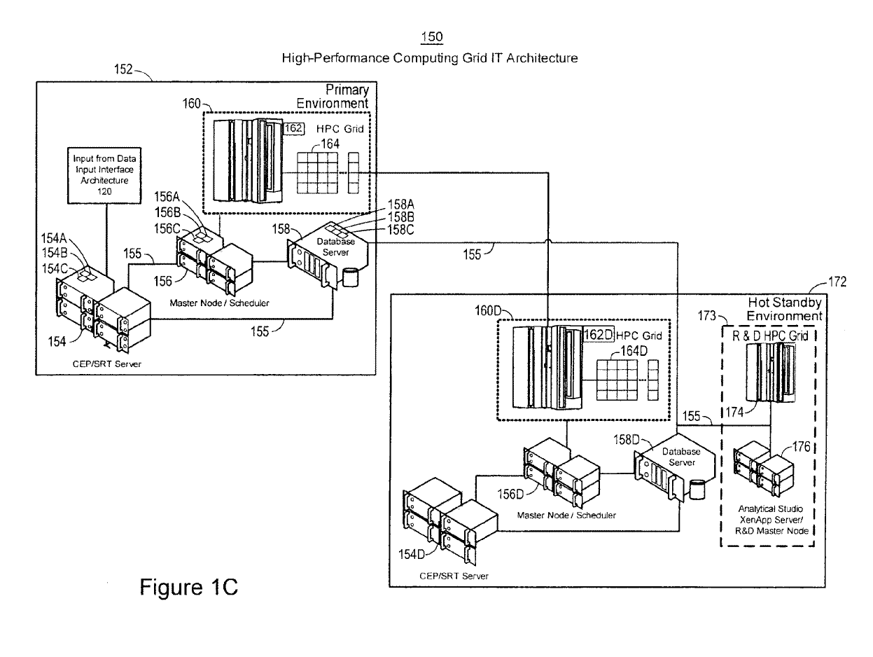

FIGS. 1A, 1B, and 1C illustrate various aspects of an exemplary architecture implementing a variable annuity hedging system 100. In particular, FIG. 1A illustrates a block diagram of a high-level architecture of the variable annuity hedging system 100 including an exemplary computing system 101 that may be employed as a component of the variable annuity hedging system 100. The high-level architecture includes both hardware and software applications, as well as various data communications channels for communicating data between the various hardware and software components. The variable annuity hedging system 100 may be roughly divided into front-end components 102 and back-end components 104 communicating via a network 106. The front-end components 102 are primarily disposed within a virtual private network (VPN) or proprietary secure network 106 including one or more real-time financial data servers 108 and users 110. The real-time financial data servers 108 and users 110 may be located, by way of example rather than limitation, in separate geographic locations from each other, including different areas of the same city, different cities, or even different states. The variable annuity hedging system 100 may generally be described as an application service provider (“ASP”) that provides computer-based services to customers over a network (e.g., the VPN 106) in a “software as a service” (SaaS) environment. In some embodiments, the system 100 and methods described herein may be provided to a user through physical or virtualized servers, desktops and applications that are centralized and delivered as stand-alone software, as an on-demand service (e.g., a Citrix® XenApp™ or other service), or as other physical or virtual embodiments. As a specialized ASP, the variable annuity hedging system 100 may provide high performance stochastic modeling of variable annuities and hedging reports.

In some embodiments, the real-time financial data server(s) 108 include or are communicably connected to a financial data service provided by Bloomberg®, Morningstar®, Quote.com®, Reuters®, etc. The real-time financial data server 108 may generally provide real-time financial market data movements and may also provide the capability of a variable annuity manager, trader, or other financial services professional to place trades and manage risk associated with variable annuities as described herein. In some embodiments, the real-time financial data server 108 provides a stream of real-time data to a data input interface, where the data stream includes a real-time risk exposure of a particular variable annuity or class of variable annuities. For example, the real-time data stream may include measures related to stock prices, interest rates, market volatility, etc. The real-time financial data server 108 may also provide news, price quotes, and messaging across the network 106.

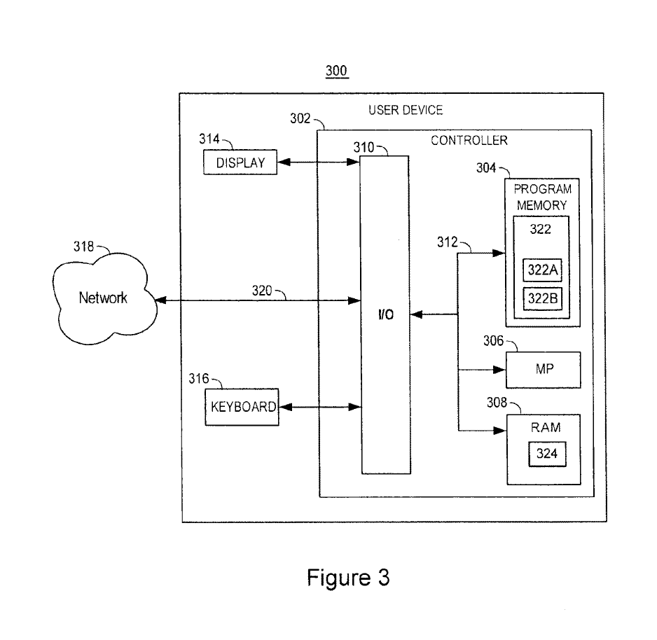

The front-end components 102 also include a number of users 110. The users may include one or more computing systems, as described herein. The computing systems may include customer servers that are local servers located throughout the VPN 106. The users may execute various variable annuity hedging applications using variable annuity hedging data created by the back-end components 104, as described below. Managers, traders, brokers, advisors, individual investors, analysts and other financial services personnel referred to collectively as “users” use the customer servers 110 to access variable annuity hedging data created by the back-end components 104. Web-enabled devices (e.g., personal computers, cellular phones, smart phones, web-enabled televisions, etc.) may be communicatively connected to customer servers 110 and the system 100 through the virtual private the network 106. In some embodiments, the variable annuity hedging system 100 may provide real time hedging data (i.e., for traders or risk managers) via an Internet browser or application executing on a user's device 300 (FIG. 3) having a data interface. For example, the variable annuity hedging system 100 may provide real-time hedging data to a user via a Microsoft® Excel® real-time data interface and through an Internet Explorer® browser. Web-based reporting tools and a central database as described herein may provide a user 110 with further flexibility.

Those of ordinary skill in the art will recognize that the front-end components 102 could also include multiple real-time financial data servers 108, customer devices 110, and web-enabled devices to access a website hosted by one or more of the customer servers 111. Each of the front-end devices 102 may include one or more components to facilitate communications between the front-end devices 102 and the back end devices 104 through a firewall 114. The front-end components 102 communicate with the back-end components 104 via the virtual private network 106, a proprietary secure network, or other connection. One or more of the front-end components 102 may be excluded from communication with the back-end components 104 by configuration or by limiting access due to security concerns. For example, web enabled devices that access a customer server 110 may be excluded from direct access to the back-end components 104. In some embodiments, the customer servers 110 may communicate with the back-end components 104 via the VPN 106. In other embodiments, the customer servers 110 may communicate with the back-end components 104 via the same VPN 106, but digital access rights, IP masking, and other wavelength division multiplex passive optical network (WDM-PON). The disclosure may also be equally applicable to variations on the GPON standard.

Other standards used for data flow within the system 100 include, but are not limited to, Data Over Cable Service Interface Specifications (DOCSIS), Digital Subscriber Line (DSL), or Multimedia Over Coax Alliance (MOCA). It should be understood that various wireless technologies may also be utilized with wireless integrated circuits utilized in the system 100, as well. Such wireless technologies may include but are not limited to the Institute of Electrical and Electronics Engineers wireless local area network IEEE 802.11 standard, Worldwide Interoperability for Microwave Access (WiMAX), Ultra-wideband (UWB) radio technology, and cellular technology.

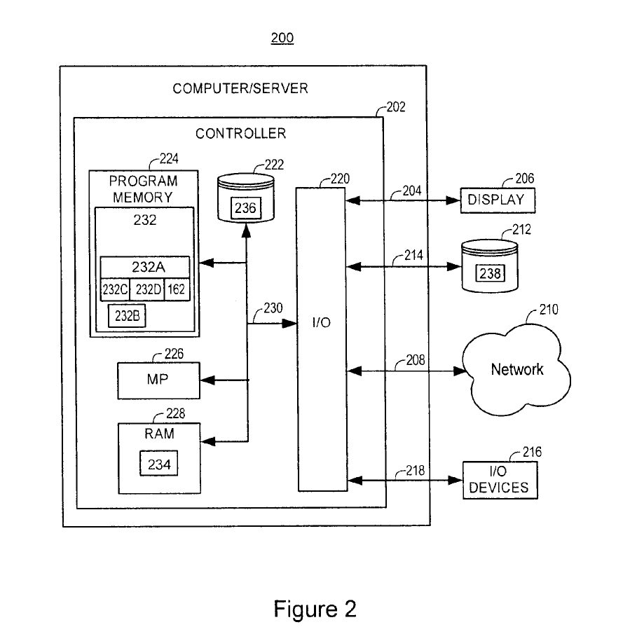

Data may flow to and from various portions of the data input interface architecture 120 through one or more firewalls 122 (FIG. 2). Generally, the firewalls 122 may block unauthorized access while permitting authorized communications through the variable annuity hedging system 100. Each firewall 122 may be configured to permit or deny computer applications based upon a set of rules and other criteria to prevent unauthorized Internet users from accessing the VPN 106 or other private networks connected to the Internet. The firewalls 122 may be implemented in either hardware or software, or a combination of both. Data from the users 110 may be balanced to distribute workload evenly across the data input interface architecture 120 using a load balancer 124. In some embodiments, the load balancer 124 includes a multilayer switch or a DNS server.

Various data inputs may be provided to the system 100 through the data input interface architecture 120 to facilitate near real-time variable annuity hedging calculations. In some embodiments, the inputs include various data streams of Inforce Extracts (e.g., data used in the valuation process in a comma-delimited file, dBase file, etc.), Net Asset Values (e.g., “NAVs” used to describe the value of a variable annuity's assets less the value of its liabilities), Intraday Trading Data, Actuarial and Risk Parameters, Bloomberg® historical data, and data from the real-time financial data server 108.

The real-time financial data server 108 and other inputs as described above may communicate with the data input interface architecture 120 through a firewall 122 to a data interface 126 (e.g., a Bloomberg® B-Pipe™ device). The data interface 126 may convert or format data sent by the financial data server 108 to the data input interface architecture 120 to a format that may be used by various applications, modules, etc., of the variable annuity hedging system 100, as herein described.

If the data is to or from the user devices 110, the data may be processed by a server group 128. The server group 128 may include a number of servers to perform various tasks associated with data sent to or from the users 110. The server group 128 may receive variable annuity portfolio data from the users. For example, using the system 100, an Insurance Company or other financial services company may send and analyze, in substantially real time, a portfolio including data for all of the company's variable annuities. This portfolio data, including multiple thousands of individual variable annuities, may be sent to and received by the server group 128. While the server group 128 illustrates three servers 130, 132, 134, those of skill in the art would recognize that the server group 128 could include any number of servers as herein described. The servers within the server group 128 may include cluster platform servers. In some embodiments, the servers 130, 132, 134 include an HP® DL380 or DL 160 Cluster Platform Proliant™ G6 or G7 server or similar type of server.

A first server 130 may be configured as a SSH File Transfer Protocol (SFTP) server that provides file access, file transfer, and file management functionality over a data stream. The first server 130 may be communicatively coupled to other servers, for example, a mass storage area or modular smart array (MSA) 136, an extract, transfer (or transform), load (ETL) server 138, and a clustered database server 140. The MSA server 136 may be configured to store various data sent from or to the users 110. In some embodiments, the MSA server 136 includes an HP® MSA70™ device. The MSA Server may store any data related to the user 110 and analysis of a user's portfolio using the system 100. In some embodiments, the MSA server 136 stores user administrative data 136A, user portfolio data 136B, and user analysis data 136C. The user admin data 136A may include a user name, login information, address, account numbers, etc. The user portfolio data 136B may include a number and type of financial instruments within a given user portfolio or book of business. For example, user portfolio data 136B may include net asset values, inforce files, actuarial assumptions, table and parameters, and other market related information as needed or required, like swap rates, implied volatilities, bond prices, and various stock market levels. The ETL server 136 may be configured to extract data from numerous databases, applications and systems, transform the data as appropriate for a Monte Carlo simulation and calculation of the Greeks, and load it into the clustered database server 140 or send the data to another component or process of the variable annuity hedging system 100. In some embodiments, the ETL server 138 and the clustered database server 140 includes one or more HP® Proliant™ DL380 G6 or similar servers.

A second server 132 may be configured as an application server to pass formatted applications and data back to the user from the back-end components 104 to the front-end components 102. The second server 132 may allow users to connect to corporate applications hosted by the variable annuity hedging system 100 including one or more applications to calculate the Greeks and conduct Monte Carlo simulations using real-time market and financial data from the financial data server 108. The application server may host applications and allow users to interact with the applications remotely or stream and deliver applications to user devices 110 for local execution. In some embodiments, the second server 132 is configured as a Citrix® XenApp™ presentation server. The second server 132 may be communicatively coupled to other servers, for example, a Complex Event Processing (CEP)/Seriatim Real Time (SRT), and XenApp™ server 142. The data interface 126 may also be communicatively coupled to the CEP/SRT XenApp™ server 142. In some embodiments, the CEP/SRT XenApp™ server includes one or more HP® Proliant™ DL380 G6 or similar servers.

A third server 134 may be configured as a web server to format and deliver content and reports to the users 110. In some embodiments, the third server 134 stores one or more procedures to generate user requested reports by accessing another server, database, or other data source of the variable annuity hedging system 100. For example, a Clustered Hedge Reporting Database (HRO) Server 140 may pass analyzed data to the third server 134 and the third server 134 may then format the analyzed data into various reports for delivery to the users 110.

A secondary site 144 may provide many of the components and functions of the data input interface architecture 120. In some embodiments, the secondary site 144 allows research and improvement of the data input interface architecture 120 by providing a mirror facility for developers to implement improvements to the variable annuity hedging system 100 in a safe environment without changing the components and functions of the “live” variable annuity hedging system 100. In some embodiments, the secondary site 144 includes components that are communicatively coupled to the data input interface architecture 120. For example, the secondary site 144 may include a computing system configured as an analytical studio/research and development master node 146 and a research and development analytical high performance computing (HPC) grid 148.

Each server of the server group 128 may communicate with a High-Performance Computing (HPC) Environment 150, as represented in greater detail in FIG. 1C. The HPC environment 150 may include various components to conduct Monte Carlo simulations and calculate the Greeks for variable annuities in a nearly real-time manner. In some embodiments, the HPC environment 150 shown in FIG. 1C includes a Primary Environment 152 that is communicatively coupled to a Hot Standby Environment 172.

The Primary Environment 152 may receive data from the Data Input Interface Architecture 120 (FIG. 1B) at a Complex Event Processing/Server Recovery Tool (CEP/SRT) Server 154. The CEP/SRT Server 154 may include instructions 154A stored in a computer-readable storage memory 154B and executed on a processor 154C to process requests for reports or other information from the users 110 (FIG. 1A), determine where to send calculation requests within the HPC Grid 160 (described below), and other complex event processing functions. The data may be passed to both a Master Node/Scheduler 156 and a Database Server 158. The Master Node/Schedule 156 may also include software modules and instructions 156A stored in a computer-readable storage memory 1568 and executed on a processor 156C to determine when and which calculation requests are sent to the various cores 164 of the HPC Grid 160. The components 154, 156, and 158 may be communicatively coupled to each other and include one or more HP® DL380 or DL 160 Cluster Platform Proliant™ G6 or G7 servers or similar types of servers.

The Database Server 158 may include one or more models 158A, assumptions 158B, and limits 158C used in calculating the Greeks, conducting Monte Carlo simulations, and other mathematical finance and analysis methods using the data that is input from the Data Input Interface Architecture 120. In some embodiments, the model 158A and assumptions 158B may include the formulas for the Greeks, as described herein, as well as documentation explaining each model. The limits 158C may include numerical or other values representing personal or well-known upper or lower acceptable thresholds for calculated Greek values, as further explained below. The models 158A and assumptions 158B may also describe a hedging strategy to manage risk for various financial instruments (e.g., futures, equity swaps, interest rate futures, interest rate swaps, caps, floors, equity index options, and other derivatives, etc.) reinsurance structuring, variable or fixed annuities, SPDRs™ and other exchange-traded funds, etc. In other embodiments, the models 158A and assumptions 158B may describe algorithms or complex problems that typically require computing performance of 1012 floating point operations per second (i.e., one or more teraflops). In addition, models 158A, assumptions 158B, and limits 158C may be dynamically updated based on customized user data, market changes, and other variable parameters. In some implementations, the database server 158 can also function as a message hub that sends and receives messages from an external trading platform that executes financial transactions based on the simulations and calculations performed by the system 100.

The CEP/SRT Server 154, the Master Node/Scheduler 156, and the database server 158 may be communicatively coupled to a High-Performance Computing (HPC) Grid 160. Generally, the HPC Grid 160 may combine computer resources from multiple administrative domains to perform high-volume, high-speed calculations to make hedging decisions for variable annuities or other complex determinations regarding user portfolios in near-real-time. The HPC Grid 160 may simultaneously apply the resources of many computers in a network to perform the various calculations needed to determine the Greeks, perform Monte Carlo simulations, and other complex calculations. The HPC Grid 160 is programmed with middleware 162 to divide and apportion the various calculations for the Greeks, Monte Carlo simulations, and other analyses of the input data 120. The middleware 162 may generally divide and apportion calculations among numerous individual computers or “computing cores” (“cores”) 164. In some embodiments, each computing core of the HPC Grid 160 may include a Graphics Processing Unit (“GPU”), while in other embodiments, the cores include the unused resources in the network 106 of the system 100. These resources may be located across various geographical areas or internal to an organization. Further, the computing cores 164 may include desktop computer instruction cycles that would otherwise be wasted during off-peak hours of use (e.g., at night, during regular periods of inactivity, or even scattered, short periods throughout the day). The middleware 162 may be stored as computer-readable instructions in one or more components of the system 100 (e.g., as instructions of the Master Node/Scheduler 156A, as part of the HPC Grid itself 160, etc.). In some embodiments, the middleware is message-oriented and exposes the computational resources of the HPC Grid 160 to other components of the system 100 through asynchronous requests and replies. Additionally, the middleware 162 may be configured to load balance analyses and various steps of analyses requiring computation across the multiple cores of the HPC Grid 160. The HPC Grid 160 may include up to thirty-thousand cores 164, but may also include many more or fewer. By adding or deleting a number of cores 164, the HPC Grid 160 may be scaled as necessary for the computation currently being performed by the grid 160.

Computation of the Greeks, Monte Carlo simulations, etc., using the data from the Data Input Interface Architecture 120 may proceed in a distributed fashion across the numerous cores 164 of the HPC Grid 160 in the Primary Environment 152 and an HPC Grid 160D of the Hot Standby Environment 172. Computation and analysis may be directed by the CEP/SRT server 154 (i.e., determining which core or cores handle a particular calculation or step of a calculation for analysis of the input data 120) and scheduling of the computations may be performed by the master node/scheduler 156. Computation and analysis may proceed in a seriatim basis and results may be delivered to the users 110 in near real-time to actual changes in active financial markets. For example, the CEP/SRT server 154 can manage the processing of over fifty thousand policies in real time, which allows the Monte Carlo simulations and other computations to be performed at multiple times throughout the day rather than just once per day as is the case with conventional implementations. In some embodiments, the CEP/SRT server 154 may access the Database Server 158 to retrieve one or more models 158A and assumptions 158B. The CEP/SRT server 154 may then distribute various steps of the retrieved models and assumptions along with data that is input from the Data Input Interface Architecture 120 to the various cores 164 of the High-Performance Computing Grid 160.

The CEP/SRT Server 154 or the master node/scheduler 156 may also include one or more software modules 154A and 156A, respectively, which translate the models 158A, assumptions 158B, and data 120 into a high-speed computing format that is more efficiently used in a networked, HPC environment. In some embodiments, a software module may include a model 158A or strategy including formulas or steps of formulas to calculate the Greeks, perform a Monte Carlo simulation, or other analyses using real-time financial market data. For example, the model 158A may include a risk analysis and hedging model for variable annuities. Some users of the system 100) may include one or more variable annuity risk hedging specifications that are calculated by or accounted for by the model 158A. For example, the hedging model 158A may include various functions describing variable annuity risk (e.g., the Greeks, a Monte Carlo Simulation, user-designed functions, etc.) that are executed by the cores of the high-performance computing environment 150 to manage and hedge risks associated with variable annuities. In some embodiments, the software modules 154A, 156A may be in byte code (e.g., big-endian, little-endian, mixed-endian, etc.) to be consistently used by all components of the HPC grid 160 or in another, custom format. In other embodiments, the models 158A and assumptions 158B may be stored within the Data Input Interface Architecture 120 and accessible for viewing or comment by the users 110. For example, in addition to a file in byte code or custom format, the models 158A and assumptions 158B may include a MATLAB® or other user-friendly model that is easily accessed, read, and understood by a user 110, but may not be immediately useful in an HPC environment.

The various servers and components of the Primary Environment 152 (i.e., the CEP/SRT Server 154, Master Node/Scheduler 156, and Database Server 158) may also include software modules or models 154A, 156A, and 158A to rebalance asset portfolios on the basis of calculation results that are returned by the High-Performance Computing grid 160. In particular, rebalancing may be performed to minimize commission and market impact costs over the lifetime of an analyzed portfolio's residual risk profile. Additional modules or models 158A may perform stress and back testing of a variety of hedging strategies using various statistical measures and routines to devise a desired hedging strategy. In some embodiments, stress and back testing may include determining the effect of basis risk on a portfolio as a measure of hedging efficiency.

The Hot Standby Environment 172 may include duplicates of the various components of the Primary Environment 152. In some embodiments, the Hot Standby Environment 172 may include a CEP/SRT Server 154D, a Master Node/Scheduler 156D, a database server 158D, and an HPC Grid 160D. The Hot Standby Environment 172 may act as a redundant system for the HPC Environment 150. As a redundant system, the Hot Standby Environment 172 may perform any of the functions of the Primary Environment 152 as described herein and permit the variable annuity hedging system 100 to operate without pause for failure or update.

The Hot Standby Environment 172 may also include several components to perform testing and other research and development tasks. In some embodiments, the Hot Standby Environment 172 includes a Research and Development HPC Grid 174 and an Analytical Studio Server I Research and Development Master Node 176. The analytical studio server/development master node 176 may include instructions stored in a computer-readable storage memory and executed on a processor to test various functions for improving the performance variable annuity hedging system 100.

With reference to FIG. 2, each of the various components described herein may also be described as a computing system generally including a processor, computer-readable memory for storing instructions executed on the processor, and input/output circuitry for receiving data used by the instructions and sending or displaying results of the instructions to a display. The various components described herein provide nearly real-time valuation of variable annuities by distributing function calculations or portions of function calculations among the cores 164 of the High-Performance Computing Grid 160. Results of these calculations are then displayed within a graphical user interface (GUI), within an Internet browser application, or in a report sent to a user 110. The results may include information in various formats such as charts, graphs, diagrams, text, and other formats. Typically, the Greeks, Monte Carlo simulations, and other analysis methods are completed to assist managers and users 110 in making hedging and other decisions for various variable annuity portfolios.

FIG. 2 depicts a block diagram of one possible embodiment of any of the servers, workstations, or other components 200 illustrated in FIGS. 1A, 1B, and 1C and described herein. The server 200 may have a controller 202 communicatively connected by a video link 204 to a display 206, by a network link 208 (i.e., an Ethernet or other network protocol) to the digital network 210, to a database 212 via a link 214, and to various other I/O devices 216 (e.g., keyboards, scanners, printers, etc.) by appropriate links 218. The links 204, 208, 214, and 218 are each coupled to the server 200 via an input/output (I/O) circuit 220 on the controller 202. It should be noted that additional databases, such as a database 222 in the server 200 or other databases (not shown) may also be linked to the controller 202 in a known manner.

The controller 202 includes a program memory 224, a processor 226 (may be called a microcontroller or a microprocessor), a random-access memory (RAM) 228, and the input/output (I/O) circuit 220, all of which are interconnected via an address/data bus 230. It should be appreciated that although only one microprocessor 226 is shown, the controller 202 may include multiple microprocessors 226. Similarly, the memory of the controller 202 may include multiple RAMs 228 and multiple program memories 224. Although the I/O circuit 220 is shown as a single block, it should be appreciated that the I/O circuit 220 may include a number of different types of I/O circuits. The RAM(s) 228 and the program memories 224 may be implemented as semiconductor memories, magnetically readable memories, and/or optically readable memories, for example.

A block diagram of an exemplary embodiment of a user device 300 as used by one or more users 110 is depicted in FIG. 3. Like the server 200, the user device 300 includes a controller 302. The controller 302 includes a program memory 304, a processor 306 (may be called a microcontroller or a microprocessor), a random-access memory (RAM) 308, and an input/output (I/O) circuit 310, all of which are interconnected via an address/data bus 312. It should be appreciated that although only one microprocessor 306 is shown, the controller 302 may include multiple microprocessors 306. Similarly, the memory of the controller 302 may include multiple RAMs 308 and multiple program memories 304. Although the I/O circuit 310 is shown as a single block, it should be appreciated that the I/O circuit 310 may include a number of different types of I/O circuits. The RAM(s) 308 and the program memories 304 may be implemented as semiconductor memories, magnetically readable memories, and/or optically readable memories, for example.

The I/O circuit 310 may communicatively connect the other devices on the controller 302 to other hardware of the user device 300. For example, the user device 300 may include a display 314 and a keyboard 316. The display 314 and the keyboard 316 may be integrated in the user device 300 (e.g., in a desktop computer, mobile phone, tablet computer, etc.), or may be a peripheral component. Additionally, the various components in the user device 300) may be integrated on a single printed circuit board (PCB) (not shown) and/or may be mounted within a single housing (not shown).

The I/O circuit 310 may also communicatively connect the controller 302 to the digital network 318, via a connection 320, which may be wireless (e.g., IEEE 802.11) or wireline (e.g., Ethernet) connections. In some embodiments, a chipset on or attached to the I/O circuit 310 may implement communication between the controller 302 and the digital network 318, while in other embodiments, an Ethernet device (not shown) and/or wireless network card (not shown) may include separate devices connected to the I/O circuit 310 via the address/data bus 312.

Either or both of the program memories 224 (FIG. 2) and 304 (FIG. 3) and databases 222 and 212 (FIG. 2) may be implemented as computer-readable storage memories containing computer-readable instructions (i.e., software) 232, 234, 236, and 238 (FIG. 2) and 322 for execution within the processors 226 (FIG. 2) and 306 (FIG. 3), respectively. The software 232-238 and 322 may perform the various tasks associated with operation of the server 200 and the user device 300, respectively, and may be a single module or multiple modules. The software 232-238 and 322 may include any number of modules accomplishing variable annuity hedging tasks related to operation of the system 100. For example, the software 232-238 depicted in FIG. 2 includes an operating system, server applications, and other program applications, each of which may be loaded into the RAM 228 and/or executed by the microprocessor 226. In some embodiments, the software described herein may include instructions 154A of the CEP/SRT Server 154 or instructions 156A of the Master Node/Scheduler 156 and either or both instructions 154A. 154B may include a variable annuity hedging program or application 232.

The software 322 of the user device 300 may include an operating system, one or more applications and, specifically, a variable annuity hedging program user interface 322. Each of the applications 232, 322 may include one or more routines or modules. For example, the variable annuity hedging application 232 may include one or more modules or routines 232A-D and the variable annuity hedging program user interface 322 may include one or more modules or routines 322A and 322B.

The variable annuity hedging application 232 may include one or more modules (e.g., modules 232A and 232B). In some embodiments, the variable annuity hedging application 232 includes a Monte Carlo System 232A as the core engine of the variable annuity hedging application 232. Other modules may depend on the Monte Carlo System 232A. For example, the Monte Carlo System 232A may include other modules such as a Cash Flow Projection Model (CFPM) 232C, an Economic Scenario Generator 232D (“ESG”), and the Grid Middleware 162. The CFPM includes a model of the cash flows associated with liability. These cash flows depend on various factors and are complex and path dependent in nature. The ESG includes a model of economic outcomes which drive the CFPM and creates nominal cash flows for the liability, as well as the expected value calculation for the liability across the different paths. The Cash Flow Projection Module 232C and Economic Scenario Generator 23D0 may both be represented to users 110 as a MATLAB® file. In implementation, the Cash Flow Projection Module 232C and Economic Scenario Generator 232D are formatted in a high-speed computing language (e.g., “C” or another language) using advanced High-Performance Computing techniques. Additionally, the modules 232A-D may be optimized for massively parallel computing.

The ESG 232D may be configured to implement a variety of models. In some embodiments, the ESG 232D includes functions to calculate one or more of Equity, Term Structure, Volatility, and Basis Risk models. For example, an Equity model may include a multidimensional geometric Brownian motion model with time-dependent volatility and drift and well as a log-normal regime switching model. A Term Structure model may include time dependent, Hull-White one-factor and two-factor models. Volatility may include a Heston model that is also time dependent. A Basis Risk model may include normal random white noise calculations. Of course, the ESG 232D may include many other models as used in hedging variable annuities. For example, the ESG 232D may be configured to include customized, risk-neutral models (i.e., may include any combination of stochastic equity, stochastic interest rates, and stochastic volatility models).

A Seriatim Real-Time Risk Monitoring module 232B (“SRT Module”) may be integrated with the HPC Grid 150 to repeatedly calculate the Greeks in seriatim and with high throughput. For example, in some embodiments, the throughput of the system 100 may update a user 110 once every five minutes for each 100,000 policies. As described herein, the SRT Module 232B is integrated with a real-time data stream 126A and may integrate hedge asset portfolio information using a real-time trade capture system for listed derivatives trades. In addition, the SRT Module 232B may support text file loading of over-the-counter executed trades to allow users 110 to monitor a complete, intra-day risk position.

Other modules on other components of the system 100 may perform various other analyses with the data stream 126A, user and trade data including valuation, stochastic-on-stochastic simulations, capital and reserve analyses to assess the effect of hedging on regulatory capital levels and reserve levels, and to evaluate the profit and loss performance of different hedging strategies. In some embodiments, the ETL Server 138 may include one or more modules to transfer various policyholder data from a user's platform to the system 100 as well as monitor and reconcile changes to user data. The Hedge Reporting Database (HRD) Server 140 may include one or more modules to control a central SQL database for tracking the system 100 and producing desired reports.

In mathematical finance, the Greeks are quantities representing the sensitivities of derivative price (e.g., option price) to a change in underlying dependent parameters for the value of an instrument or portfolio of financial instruments. The Greeks may also be referred to as risk sensitivities, risk measures, or hedge parameters. Variable annuity portfolio managers may use the Greeks to measure the sensitivity of the value of a portfolio to a small change in a given underlying parameter. Using these measures, component risks may be treated in isolation and each variable annuity portfolio rebalanced to achieve desired exposure.

First order derivatives Delta, Vega, Theta and Rho as well as Gamma (a second-order derivative of the value function) are the most common Greeks, although many higher-order Greeks are used as well and are included with the variable annuity hedging application 232. Fair market value (FMV) is another example of a Greek that reflects changes in interest rate over time, which can be represented as an interest rate curve that is shifted over time to reflect market conditions. Each equation described below may be converted into computer-readable instructions by a component of the system (e.g., the CEP/SRT Server 154) to be calculated in near real time using financial market data 108A and the HPC Grid 150.

Delta Δ measures an option value's rate of change with respect to changes in the underlying asset's price, as shown below by Equation 1, where V is Value (interchangeable with C for “cost”) and S is price.

$$Δ = \frac{\partial V}{\partial S} \qquad ( Equation 1 )$$

Vega ν measures sensitivity to volatility and is generally described as the derivative of the option value with respect to the volatility of the underlying asset, as shown below by Equation 2, where V is Value and σ is volatility.

$$υ = \frac{\partial V}{\partial σ} \qquad ( Equation 2 )$$

Theta θ is generally described as “time decay” of an underlying asset and measures the sensitivity of derivative's value to time, as shown below by Equation 3, where V is value and τ is time.

$$θ = \frac{\partial V}{\partial τ} \qquad ( Equation 3 )$$

Rho ρ generally describes the sensitivity of the underlying asset to the interest rate. Rho may be measured by the derivate of the asset value with respect to a risk-free interest rate, as shown below by Equation 4, where V is value and r is the interest rate.

$$ρ = \frac{\partial V}{\partial r} \qquad ( Equation 4 )$$

Gamma Γ is the rate of change in the value of Delta with respect to change in the underlying asset price, as shown below by Equation 5, where Δ is the value of Delta described above and S is the underlying asset price.

$$Γ = \frac{\partial Δ}{\partial S} \qquad ( Equation 5 )$$

Other higher-order Greeks may be included with the variable annuity hedging application 232 and used with the system 100 to hedge variable annuities. For example, higher-order Greeks include Charm (i.e., delta decay or DdeltaDtime), Color (i.e., gamma decay or DgammaDtime), DvegaDtime, Lambda (i.e., Omega or Elasticity), Speed (i.e., the gamma of the gamma or DgammaDspot), Ultima (i.e., OvommaDvol), Vanna (i.e., DvegaDspot and DdeltaDvol), Vomma (i.e., Volga, Vega Convexity, Vega gamma or dTau/dVol), and Zomma (i.e., DgammaDvol). The system 100 may calculate each of Greek values discussed above using market data received by the High-Performance Computing Environment 150 (FIGS. 1B and 1C) through the data input interface architecture 120. In some embodiments, the system 100 may include a Greeks software module 154A that includes instructions executed by a processor 226 to employ an HPC Grid 160 to calculate the Greeks within a Monte Carlo simulation and display the results to a user 110.

The variable annuity hedging application user interface 322 may include one or more modules (e.g., modules 322A and 322B) to assist the user in managing the variable annuity hedging system 100. In some embodiments, the modules include computer instructions to input user administrative data 136A and portfolio data 136B, to display reports illustrating the results calculating the Greeks, Monte Carlo simulations and other analyses, to manipulate portfolio data 136B to more closely reflect user limits 158C, to implement transactions to optimize portfolio data 136B according to calculation of the Greeks, Monte Carlo simulations and other analyses, etc.

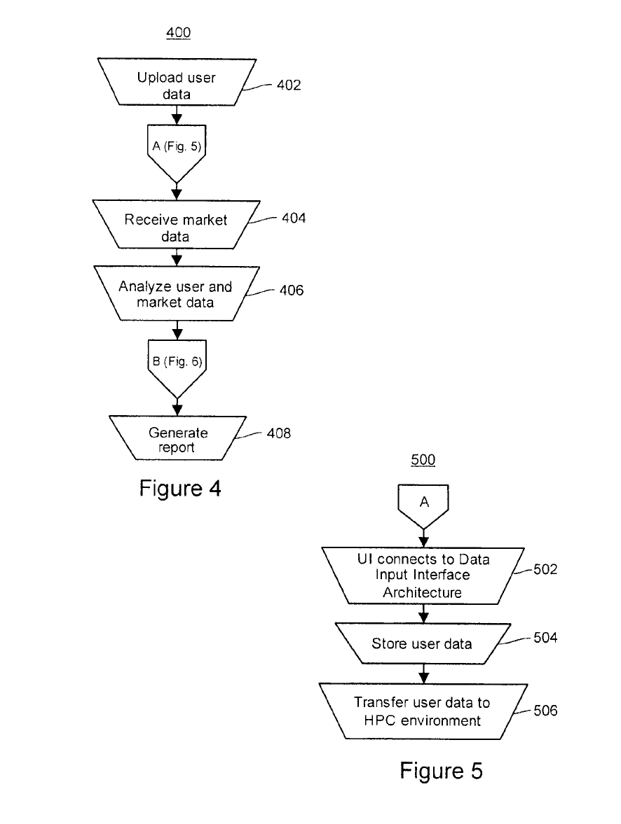

The system 100 may use market data received by the High-Performance Computing Environment 150 (FIGS. 1B and 1C) through the data input interface architecture 120 to calculate the Greeks, perform a Monte Carlo simulation, and other analyses. With reference to FIGS. 1-5, a method 400 for using the data 120 for managing a variable annuity hedging program is herein described. The method 400 may include one or more functions that may be stored as computer-readable instructions on a computer-readable storage medium, such as a program memory 224, 304, including the variable annuity hedging program or application 232, and various modules (e.g., 232A. 232B, 154A, 156A, and models 158A, assumptions 158B, and limits 158C), as described above. The instructions are generally described below as “blocks” or “function blocks” proceeding as illustrated in the flowchart of FIGS. 4, 5, and 6. While the blocks of FIGS. 4, 5, and 6 are numerically ordered and described below as proceeding or executing in order, the blocks may be executed in any order that would result in analyzing real-time market data to calculate the Greeks, perform a Monte Carlo simulation, or other near-real-time analyses employing a High Performance Computing grid to manage a hedging program, as described herein.

A user may input user data into the MSA server 136 or another data storage area (e.g., databases 222, 212, database server 158, etc.) (block 402). On a user device 300, the user 110 may cause the variable annuity hedging application user interface 322 to load into program memory 304 and further cause the user interface 322 to upload user admin data 136A, user portfolio data 136B, or other data.

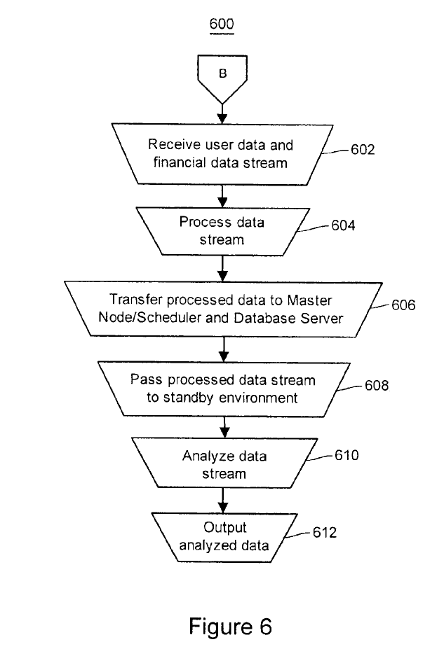

With reference to FIG. 5, a data input method 500 may connect to the Data Input Interface Architecture 120 (block 502). In some embodiments, the users 110 may include the variable annuity hedging application user interface 322. Using the interface 322, the users 110 may securely connect to the Data Input Interface Architecture 120 through a virtual private network 106 and firewall 122 or other secure connection. At block 504, the method 500 may store the user data within the back-end components 104 of the system 100. In some embodiments, a load balancer 124 may instruct the SSH File Transfer Protocol (SFTP) server 130 to store user data 136A and 136B at the MSA server 136. The method 500 may also transfer the user data to the HPC environment 150 (block 506). In some embodiments, the extract, transfer, load (ETL) server 138 may move the user data 136A and 136B to the clustered database server 140. In some embodiments, the ETL server may extract, transform, and load the data 136A, 136B from the MSA 136 to the database server 140.

Returning to FIG. 4, the system 100 may receive market data (block 404). In some embodiments, the real-time financial data server 108 may stream financial market data 108A through a virtual private network or other secure connection to a firewall 122 and to the data interface 126 (e.g., a Bloomberg® B-Pipe™ device 126). The data interface 126 may then forward the data stream 126A to the CEP/SRT server 142. The CEP/SRT server 142 may then forward the data stream 126A to the HPC Environment 150.

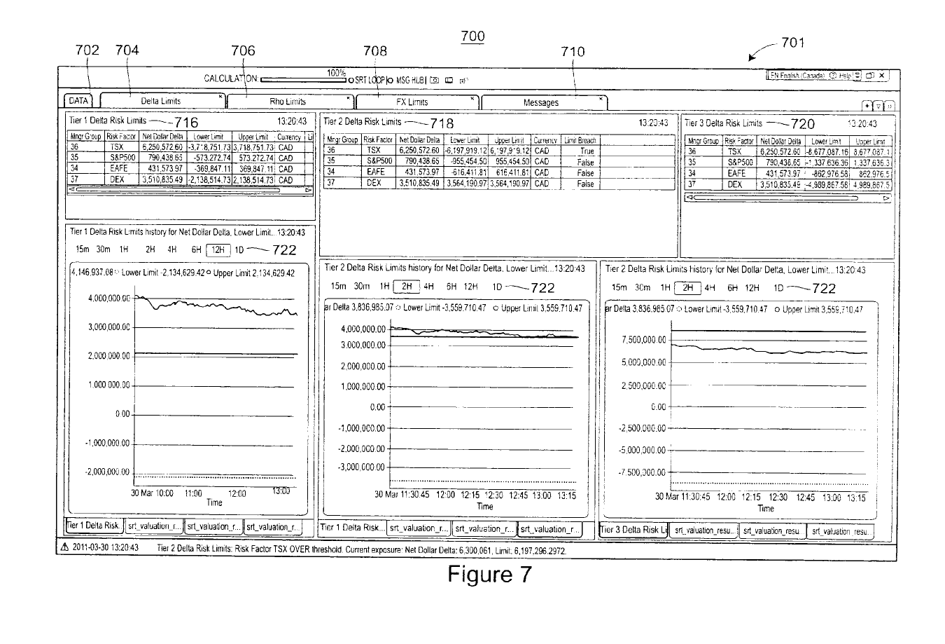

At block 406, the method 400 may analyze the user and market data. With reference to FIGS. 1C and 6, a High-Performance Computing Grid Architecture 150 may employ a method 600 to analyze the user and market data 136A, 136B, and 126A. The method 600 may be stored as one or more software modules of the instructions 154A stored in the computer-readable storage memory 154B and executed on the processor 154C. At block 602, the method 600 may receive the user data 136A, 136B and the financial data stream 126A from the Data Input Interface Architecture 120. In some embodiments, a CEP/SRT server 154 receives the data 136A, 136B, and 126A. At block 604, the CEP/SEP server 154 may process the data stream 126A to facilitate complex calculations such as the Greeks, Monte Carlo simulations, and other analyses as described herein. For example, the CEP/SRT server 154 may include instructions 154A stored in the memory 154B and executed on the processor 154C to parse the data stream 126A for one or more formulas or portions of formulas as described above to calculate the Greeks (e.g., modules 232A and 232B). The CEP/SRT server 154 may then pass the processed data stream 155 to the Master Node/Scheduler 156 and the database server 158 (block 606).

At block 608, instructions 158A stored in the memory 158B and executed on the processor 158C of the database server 158 may pass the processed data stream 155 to the Hot Standby Environment 172. The Hot Standby Environment 172 may receive the processed data stream 155 at a data base server 1580. The database server 1580 may include instructions stored in a memory and executed on a processor to store the processed data stream 155 and pass the processed data stream 155 to other Hot Standby Environment 172 components (e.g., the CEP/SRT server 154D, the Master Node/Scheduler 156D, the HPC Grid 160D, etc.). Each of the components of the Hot Standby Environment 172 may generally perform the same functions of the Primary Environment 152 in parallel, as described herein.

In some embodiments, the HPC Grid IT Architecture 150 also includes a Research and Development (R&D) cell 173 including an R&D HPC Grid 174 and an R&D Master Node 176. The R&D Cell 173 may also receive the processed data stream 155 and provide a testing environment for other functions, methods, instructions, etc., to analyze the data steam 155.

At block 610, computer readable instructions 154A, 156A stored on a computer readable memory 154B, 156B and executed by a processor 154C, 156C (e.g., the variable annuity hedging application 232) of the CEP/SRT Server 154 or the Master Node/Scheduler 156 may facilitate calculation of various analyses (e.g., the Greeks, Monte Carlo simulations, etc.) using the HPC Grid 160. In some embodiments, a scheduling algorithm 156A uses the processed data 155, model 158A, assumptions 158B, and limits 158C as well as the middleware 162 to generally divide and apportion calculations among numerous individual computers or cores 164 of the HPC Grid 160. The method 600 may output the data analyzed by the HPC Grid 160 at block 612.

Returning to FIG. 4, the method 400 may generate various reports or other graphical and textual representations of the analyses performed by the method 600 (block 408). In some embodiments, the HPC Environment 150 may pass the results output (block 612) to the Clustered Hedge Reporting Database (HRD) Server 140 (FIG. 1B). The Clustered HRD Database Server 140 may then pass the results to various components of the Data Input Interface Architecture 120 such as the MSA 136 and the third server 134. As described above, the third server 134 may be configured to generate one or more reports including the analyzed data described by the method 600. The reports generated by the third server 134 may then be published to the users 110 through load balancer 124, firewall 122, and VPN 106. In some embodiments, the third server 134 is a web server and the reports include seriatim valuation reports and sensitivity analysis reports over various periods of time (e.g., hourly, daily, weekly, monthly, etc.). For example, the third server 134 may include a LucidReport™ web server 134 generating profit and loss attribution for every user subaccount, equity market input, Rho bucket, unhedged components, Greeks and second order Greeks, and policyholder behaviors. Other reports produced by the web server 134 may include monthly hedge effectiveness, daily reconciled trades, quarterly futures, actual vs. expected claims and policyholder status, collateral and variation margins, weekly capital and reserves, and limit breach reports.

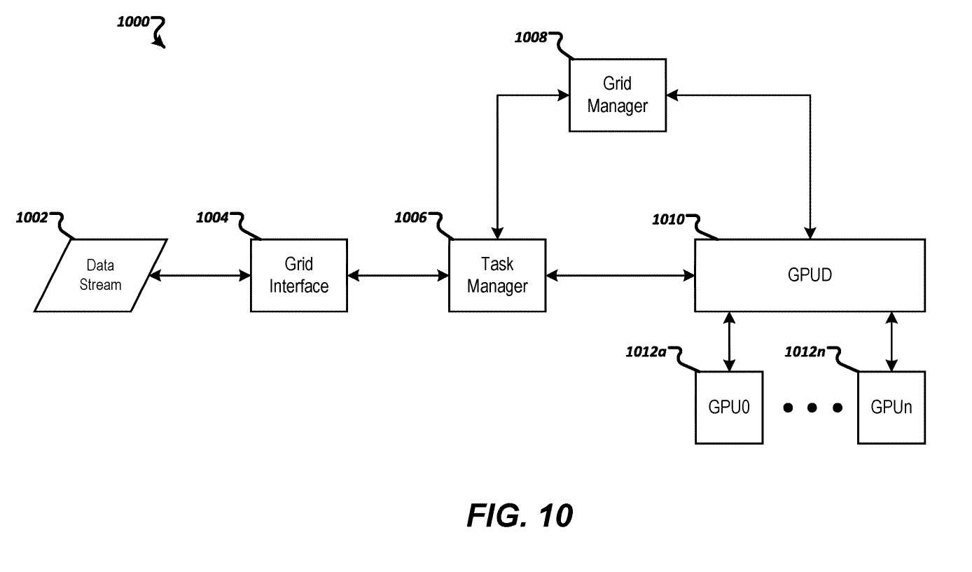

Turning to FIG. 10, a block diagram of a HPC grid architecture 1000 is illustrated, which can be an alternate representation of the HPC grid environment described previously (FIG. 1C). A grid interface 1004 receives an incoming data stream 1002, which can include data from the data input interface architecture 120 of FIG. 1A, for example. The incoming data stream, in some examples, can include user administrative data 136A and portfolio data 136B as well as the models 158A, assumptions 158B, and limits 158C stored in the database server 158, as described in FIGS. 1B and 1C, respectively. For example, the data stream 1002 can include end of real time market data that is used by the HPC grid architecture 1000 to execute Monte Carlo simulations or other types of calculations in order to develop trading strategies at multiple times of the day. Each data stream 1002 may include any data associated with performing evaluations for one or more policies. In some implementations, the grid interface 1004 transforms the data stream 1002 into data structures having a predetermined format compatible with the hardware of the HPC grid architecture 1000 that includes the GPUs 1012. In one example where the incoming data stream 1002 is written in Python code, the grid interface 1004 transforms the Python code including Numpy and HDF5 arrays into the internal data structure format and feeds the transformed data stream to task manager 1006.

The task manager 1006, in some embodiments, controls allocation of processing tasks to one or more GPUs 1012 of a processing grid, such as the HPC grid 160 of FIG. 1C, by communicating directly with a grid manager 1008 and GPU daemons (GPUDs) 1010. In one example, the task manager 1006 maintains Transmission Control Protocol/Internet Protocol (TCP/IP) connections to the grid manager 1008 and any allocated GPUDs 1010. The grid manager 1008 dynamically allocates and deallocates the GPUs 1012 via the GPUD 1010 for various processing tasks based on control signals received from the task manager 1006. In some examples, allocation and deallocation of multiple GPUDs for various processing tasks can occur simultaneously in parallel, which improves processing efficiency of the system 100.

In some implementations, the components of the HPC grid architecture 1000 operate in sessions in response to receiving an incoming data stream 1002. For example, when the transformed data stream is passed to the task manager 1006 from the grid interface 1004, the task manager 1006 initiates a begin_session( ) call to the grid manager 1008 to commence the allocation of the GPUDs 1010 and associated GPUs 1012 to process the data in the data stream 1002. When the task manager 1006 determines that all of the computation results associated with the data stream 1002 have been processed and received from the GPUD 1010 or if an unexpected disconnection between the task manager 1006 and the GPUD 1010 and/or grid manager 1008 occurs, the task manager 1006 concludes the session by issuing an end_session( ) call to the grid manager 1008. Each session can have one or more allocated GPUDs 1010, which can be dynamically allocated and deallocated during run-time of a session, and the grid manager 1008 acts as a central registry for the sessions. Details regarding the allocation and deallocation of GPUDs 1010 and associated GPUs 1012 are described further herein.

The GPUs 1012 represent individual processing resources, such as the cores 164 of the HPC grid 160. The GPUD 1010 controls one or more GPUs 1012 and executes commands received from the task manager 1006 associated with each of the GPUs 1012 and passes any computation results from the GPUs 1012 back to the task manager 1006. In some implementations, the GPUs 1012 can be part of a homogeneous environment or a heterogeneous environment. In a homogeneous environment, the GPUs 1012 as well as the other components of the HPC grid architecture 1000 are entirely cloud-based or non-cloud-based processing resources. In a heterogeneous environment, the GPUs include a combination of cloud-based and non-cloud-based processing resources, and the other components of the HPC grid architecture 1000 may include both cloud-based and non-cloud-based resources. In some implementations, in a heterogeneous environment, the task manager 1006 can make processing resource allocation decisions based on connectivity parameters (e.g., network latency, bandwidth) indicating a connection quality between the cloud-based and non-cloud based resources.

In some implementations, the functions associated the blocks of the HPC grid architecture 1000 can be performed by one or more components of the primary environment 152 and the hot standby environment 172 of the HPC grid architecture 150 described in relation to FIG. 1C. For example, the functions associated with the grid interface 1004 may be performed by the CEP/SRT server 154, the functions associated with the task manager 1006 can be performed by the Master Node/Scheduler 156, and the functions associated with the grid manager 1008 can be performed by the middleware 162 executed by one of the servers of the HPC grid architecture 150. In addition, the GPUDs 1010 and GPUs 1012 can represent the cores 164 of the HPC grid, as described in relation to FIG. 1C.

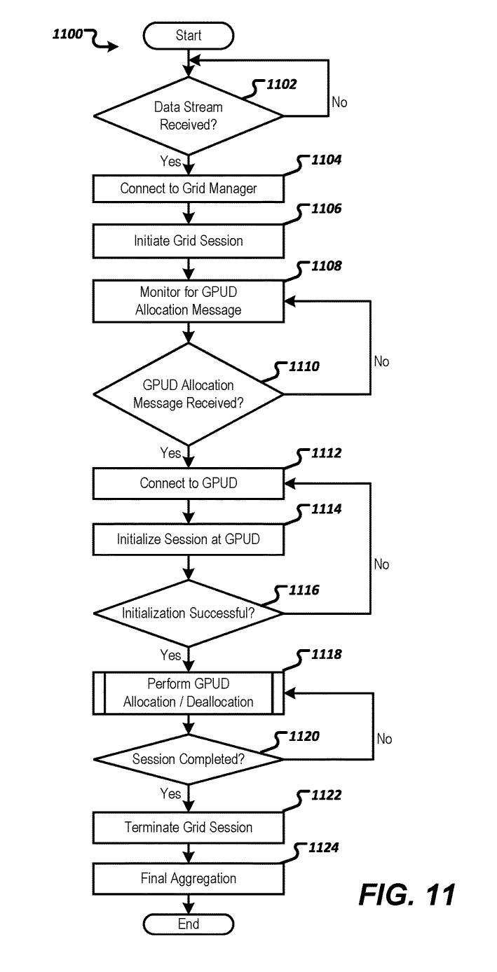

Turning to FIGS. 11-13, methods for managing a computing grid with respect to the HPC grid architecture 1000 are described. In the method 1100 illustrated in FIG. 11, in some implementations the method begins with determining that a transformed data stream has been received (1102). Responsive to determining that the transformed data stream has been received, in some implementations, the task manager 1006 connects to the grid manager 1008 (1104) by establishing a TCP/IP connection and sending a begin_session( ) call message to the grid manager 1008 to initiate a session to process the data stream (1106). In response to receiving the begin_session( ) call message, in some implementations, the grid manager 1008 allocates a GPUD 1010 for the session and returns a GPUD allocation message to the task manager 1006. In some embodiments, multiple GPUD allocations can occur in parallel except for the initial GPUD allocation that occurs in response to the begin_session( ) call message.

Once the grid session is initiated, in some implementations, the task manager 1006 monitors incoming message signals from the grid manager 1008 for a GPUD allocation message indicating that a GPUD 1010 has been allocated for the session (1108). If a GPUD allocation message is received (1110), in some implementations, the task manager 1006 then connects to the allocated GPUD 1010 (1112). In some embodiments, the GPUD allocation message includes an IP address and port for the GPUD 1010, which is used by the task manager 1006 to establish a TCP/IP connection with the GPUD 1010. In addition, in some embodiments, a two-way handshake occurs between the task manager 1006 and the GPUD 1010 during establishment of the connection to ensure that the task manager 1006 is actually connected to the GPUD 1010.

The task manager 1006, in some implementations, initializes a session at the GPUD 1010 (1114) once the connection between the GPUD 1010 and the task manager 1006 is established. To initialize the session at the GPUD 1010, the task manager 1006 may upload any data that is used by the GPUD 1010 and associated GPUs 1012 to perform the allocated processing tasks. For example, the task manager 1006 can upload any specific computing platform architecture data (e.g., Compute Unified Device Architecture (CUDA) model binaries) to the GPUD 1010 during session initialization. Session initialization may also include sending a session name to the GPUD 1010 along with any models 158A, assumptions 158B, and limits 158C that are used to perform processing tasks associated with the incoming data stream 1002, as described in relation to FIG. 1C. In response to the initialization, in some embodiments, the GPUD 1010 pre-processes the models 158A, assumptions 158B, and limits 158C and allocates computing platform resources for the session.

If the GPUD session initialization is successful (1116), in some implementations, the GPUD 1010 is then added to a list of active workers to be sent work by the task manager 1006. In some implementations, if the GPUD initialization is unsuccessful, then the task manager 1006 can reattempt to connect to the GPUD 1010 (1112) and/or initialize the session at the GPUD 1010 (1114). Except for the initial GPUD initialization in a session that occurs in response to the begin_session( ) message call, in some embodiments, the GPUD connection and session initialization can run in parallel for multiple GPUDs 1010 (1112-1116).

In response to a successful session initialization between the task manager 1006 and at least one GPUD 1010, in some implementations, the task manager 1006 allocates and deallocates processing resources associated with the GPUD 1010 (e.g., GPUs 1012) to perform the processing tasks associated with the incoming data stream 1002 (1118). The task manager 1006 can simultaneously transmit processing tasks to multiple GPUDs 1010, receive computation results from GPUDs 1010, and aggregate the received computation results from all of the GPUDs at the end of a session into a single array. For example, for Monte Carlo computations, a corresponding data packet includes one item from the input array. For Data Parallel models, a data packet includes a batch of multiple items from the input array.

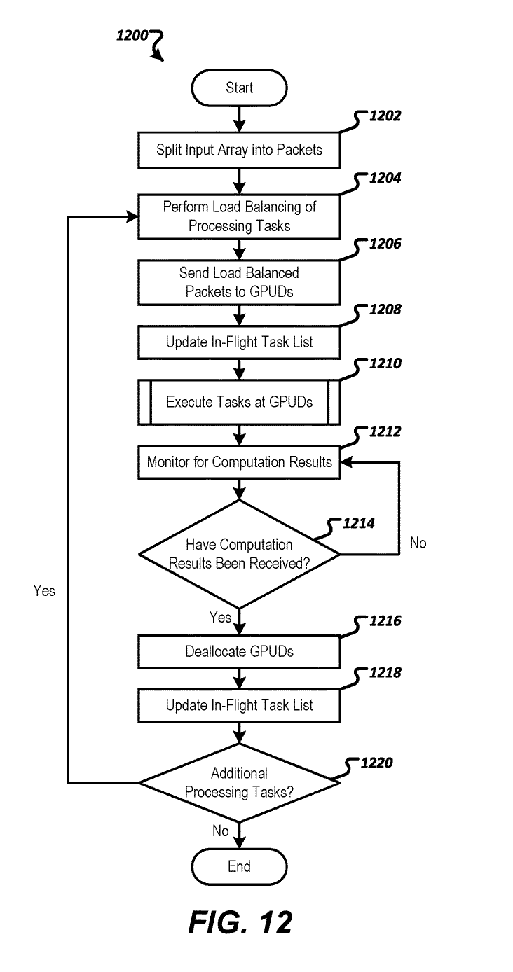

FIG. 12 illustrates a flow diagram of a method 1200 for processing resource allocation and deallocation. When a session is initialized between the task manager 1006 and at least one GPUD 1010 in response to receiving data stream 1002 that includes an input array, in some implementations, the task manager 1006 divides the input array into data packets in preparation for sending the data packets to the GPUDs 1010 (1202). In some embodiments, each of the data packets corresponds to a specific processing task to be performed by one of the GPUs 1012 associated with an allocated GPUD 1010.

In addition, the task manager 1006, in some implementations, load balances the processing task allocation assignments for the data packets at each of the GPUDs 1010 in order to improve network performance and achieving saturation conditions at the GPUD 1010 and associated GPUs 1012 (1204). In some embodiments, to saturate the GPUDs 1010, the task manager 1006 assigns multiple processing tasks to the GPUDs 1010. In one example, three processing tasks are assigned to each GPUD 1010 at a time, but the number of simultaneously assigned processing tasks can be increased or decreased based on various factors processing capabilities of the GPUs 1012. For example, the processing tasks can be proportionately divided among deallocated GPUDs 1010 so that additional processing tasks can be allocated to GPUDs 1010 when other processing resources are in use. In addition, some processing tasks may have a higher priority than other processing tasks based on a type of computation with which the processing task is associated.

Once the processing tasks for an input array have been assigned to GPUDs 1010 that are available for allocation, the task manager 1006, in some implementations, transmits the data packets associated with the processing tasks to the GPUDs (1206) and updates an in-flight task list (1208) to keep track of which processing tasks have been sent to each specific GPUD 1010. If a GPUD 1010 unexpectedly disconnects from the task manager 1006 or crashes, in some embodiments, the task manager 1006 can resend the processing tasks to the GPUD 1010 upon reconnection based on the processing tasks associated with the GPUD 1010 on the in-flight task list.

In response to receiving the data packets associated with the assigned processing tasks from the task manager 1006, in some implementations, the GPUD 1010 controls execution of the processing tasks by the GPUs 1012 (1210). In some embodiments, the GPUDs 1010 internally maintain a queue of incoming tasks, which are balanced between the GPUs 1012 controlled by the GPUD 1012. As processing tasks are executed, the GPUs 1012 and GPUDs 1010 reach checkpoints at which internal operations are performed that are transparent to users of the system 100. For non-aggregate computations, the checkpoints function as a synchronization barrier after which the GPUDs 1010 are ready to process additional processing tasks. Non-aggregate computations are processing tasks whose computations results are not dependent on one another to generate additional computation results. For aggregate computations, the checkpoints ensure that the task manager 1006 has received the aggregate results for a previously calculated computation. Aggregate results refer to computation results for related processing tasks that are dependent on one another to produce additional computation results. The aggregate results can be collected at the checkpoints so that the additional computation results can be calculated. For aggregate computations, in some embodiments, the task manager 1006 also maintains a list of tasks that have not yet been covered by a checkpoint at a GPU 1012 and/or GPUD 1012.

The implementation of the internal checkpoints throughout the execution of the processing tasks, for example, allows for dynamic allocation and deallocation of GPUDs 1010 and supports fault tolerance. In some examples, fault tolerance may be achieved through internal check-points such as time-outs or status messages that are issued to the GPUDs 1010 by the task manager 1006 at predetermined time intervals or in predetermined situations to ensure that the GPUDs 1010 are functioning properly. For example, if a computation result for an assigned processing task or a response to a status message is not received from a specific GPUD 1010 within a predetermined time period, the task manager 1006 may flag the specific GPUD 1010 as unavailable for allocation of processing tasks. In addition, any processing tasks that had previously been assigned to the GPUD 1010 flagged as unavailable may be assigned to another available GPUD 1010, and no further processing tasks may be assigned to the unavailable GPUD 1010 until a response is received from the unavailable GPUD 1010.

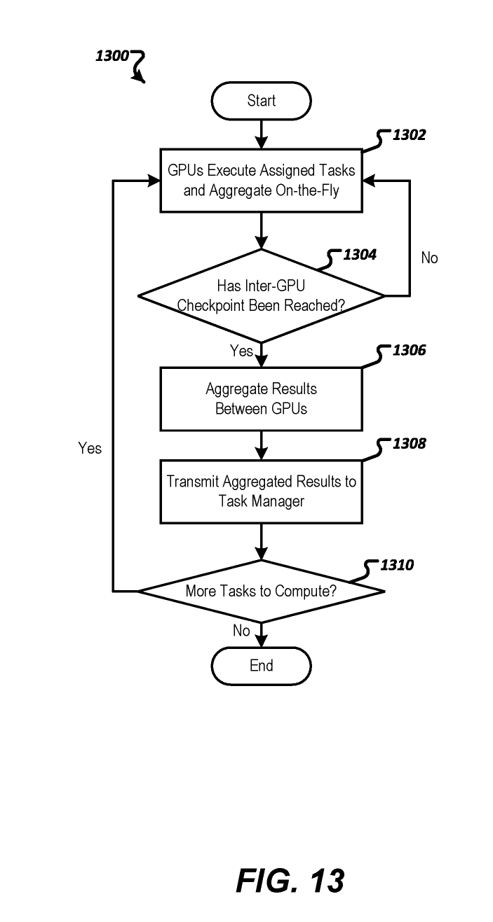

FIG. 13 illustrates a flow diagram of a method 1300 for GPUD task execution. In some implementations, each of the GPUs 1012 executes processing tasks assigned by the GPUD 1010 and aggregates the corresponding computation results on-the-fly (1302). In other words, each GPU 1012 is able to aggregate computation results for the tasks processed by the individual GPU 1012 without synchronization of processing with the other GPUs 1012 controlled by the GPUD 1010. If an inter-GPU checkpoint has been reached (1304), in some implementations, the GPUD 1010 controls synchronization of computation results between the GPUs 1012 and combines individual GPU aggregation results into a combined aggregation result for the GPUD 1010 (1306), which is transmitted back to the task manager (1006). If there are additional processing tasks to compute (1310), in some implementations, the GPUs 1012 continue to execute assigned tasks (1302) until all of the assigned tasks for the GPUD 1010 have been processed.

Referring back to FIG. 12, in some implementations, the task manager 1006 monitors the GPUDs 1010 for computation result transmissions (1212). In response to receiving computation results from any of the GPUDs 1010 (1214), in some implementations, the task manager 1006 deallocates the GPUDs 1010 from the assigned processing tasks (1216) and updates the in-flight task list to reflect the deallocation (1218) so that the deallocated GPUDs 1010 can be allocated for other processing tasks. In addition, different types of computation results can be collected in different formats at the task manager 1006. For example, computation results can be collected as individual data arrays or the computation results can be copied into a single array as the results are returned to the task manager 1006 from the GPUDs 1010. If there are additional processing tasks associated with the data stream 1002 that have not yet been allocated to a GPUD 1010 for execution (1220), the task manager 1006, in some embodiments, performs load balancing to assign any remaining processing tasks to deallocated GPUDs 1010.

Referring back to FIG. 11, if the task manager 1006 has received all of the computation results for a data stream 1002 indicating that the session has completed (1120), in some implementations, the task manager 1006 then initiates an end_session( ) call message to the grid manager 1008 and GPUDs 1010 to terminate the grid session (1122). In some embodiments, when the end_session( ) call message is sent, the task manager 1006 stops accepting GPUD allocation messages from the grid manager 1008 and transmits session clean-up requests to the GPUDs 1010 to collect any remaining computation results. In addition, session clean-up can also be performed if the task manager 1006 disconnects from a GPUD 1010 unexpectedly.

The task manager 1006, in some implementations, performs a final aggregation of all computation results for the session when the session is terminated (1124) by aggregating the computation results from all of the GPUDs 1010 into a single output array, and returning the output array to the grid interface 1004. Once the final aggregation has been performed, the task manager 1006 may disconnect from at least one of the grid manager 1008 and the GPUDs 1010. The data entries in the output array can correspond to policy evaluation data for the received data stream 1002 that can be output to the users 110 as the reports discussed previously herein.

The computing grid management processes described herein with respect to the HPC grid architecture 1000 greatly improve the processing efficiency and capabilities of the computing resources of the system 100 and allows variable annuity calculations to be performed in real time in response to receiving an incoming data stream 1002 that includes financial market data and variable annuity portfolio data in addition to any models 158A, assumptions 158B, or limits 158C that are used by the computing grid (e.g., GPUDs 1010 and GPUs 1012) to execute the Monte Carlo simulations or other types of computations that may be used to develop future trading strategies. For example, the simultaneous allocation/deallocation of GPUDs 1010 and load balancing of processing resources between the GPUDs 1010 of the computing grid by the task manager 1006 improves network performance and allows saturation conditions to be achieved at the computing grid without overtaxing just a few of the available processing resources.

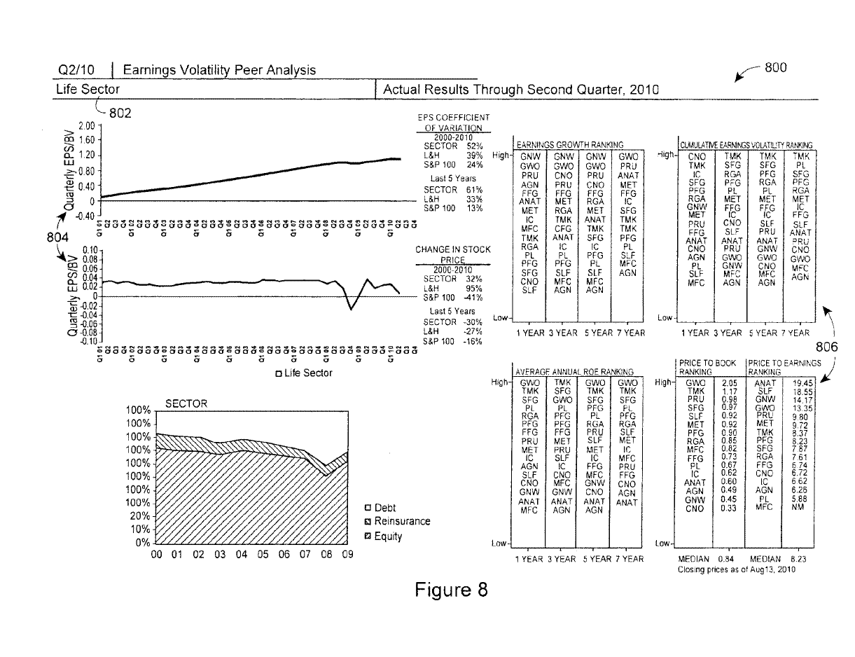

With reference to FIG. 7, the system 100 may generate and display one or more reports and real-time analysis within a user interface 700 or “Operations Control Center” (OCC). Using the HPC Environment 150 and various methods, models, and functions described herein, the reports may be displayed to a user intraday such that the user is able to make risk hedging decisions for variable annuities substantially in real time when compared to the age of the data received from the financial data server 108. The OCC 700 may include a “Seriatim Real-Time” user interface 701 (“SRT UI”) in communication with the Complex Event Processing (CEP)/Seriatim Real Time (SRT), and XenApp™ server 142, the Seriatim Real-Time Risk Monitoring module 232B (“SRT Module”) and other components and modules of the system 100. The SRT UI may display any of the data and calculation results as described herein. For example, the SRT UI 701 may organize the data and results within tabs that can include tabs for data 702, Delta limits 704, Rho limits 706, FX limits 708, and messages 710. The tabs 702, 704, 706, 708, and 710 may include data and calculations related to the calculation of the Greeks. For example, the Delta limits 704 tab may display Tier 1 716, Tier 2 718, and Tier 3 720 Delta Risk Limits. For example, each tier represents when a risk limit is breached, and each tier may have a different action associated with the tier. For example, when Tier 1 716 is breached, a course of action may be determined based on a net result that causes a return to a neutral value that does not exceed a limit. When Tier 2 718 is breached, an email notification may be sent to one or more users. When Tier 3 720 is breached, then a notification may be sent to a managing executive, such as a chief financial officer (CFO). The notifications can be sent out in real time in response to detection of a breach of any of the tiers. Each of the Delta Risk Limits 716, 718, and 720 may display calculation results over a range of configurable time periods 722. The Rho Limits tab 706 and the FX Limits tab 708 may display risk limits over configurable time periods, as well.

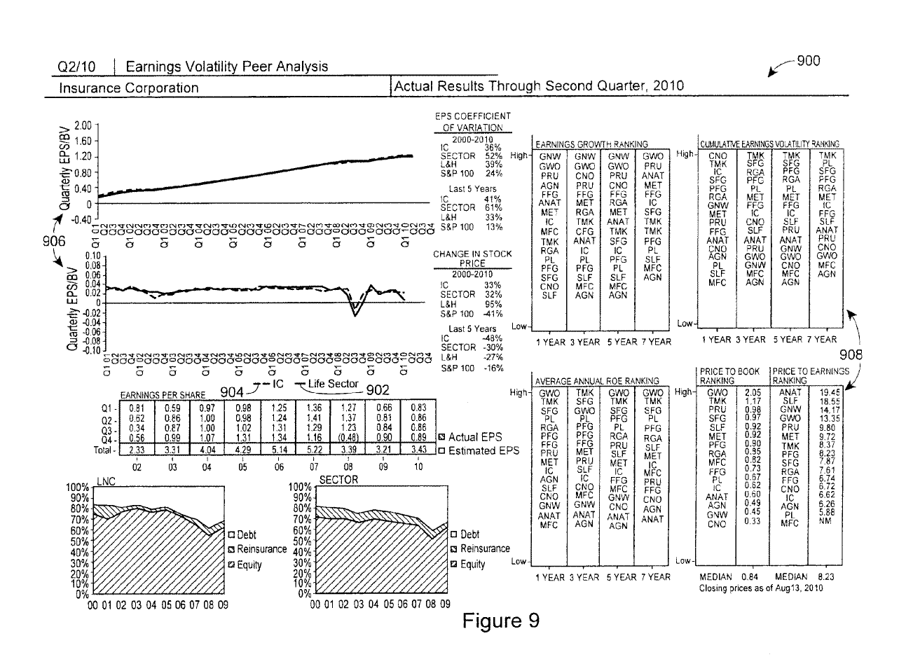

With reference to FIGS. 8 and 9, the system may generate and display other reports including an Earnings Volatility Peer Analysis for a portfolio including all of the company's variable annuities. This portfolio data, including multiple thousands of individual variable annuities. As shown in FIG. 8, a sector analysis 800 may include an analysis by a particular sector 802 and an analysis of that sector's earnings per share and book value 804. As a peer analysis, the report 800 may generate ranking reports 806 for various companies within that sector 802 according to various measures (e.g., earnings growth, cumulative earnings volatility, average annual return on equity (ROE), price to book, price to earnings, etc.). As shown in FIG. 9, a combined company and sector analysis 900 may include an analysis by a particular sector 902 as well as for a particular company 904. As with the sector analysis 800, the combined company and sector analysis 900 may include an analysis of that sector's earnings per share and book value 906. Further, the report 900 may generate ranking reports 908 for various companies within a sector 902 including the particular company 904 within that ranking, and according to various measures (e.g., earnings growth, cumulative earnings volatility, average annual return on equity (ROE), price to book, price to earnings, etc.). Of course, each report 800 and 900 may include other analyses and rankings as permitted by the data generated by the system 100 using the portfolio data and market data within the risk model.

The system and method for managing a variable annuity hedging program as described herein may generally provide a comprehensive solution and expert consulting support for developing, pricing, and hedging variable annuities. The variable annuity hedging system 100 described herein may also allow a user to transfer a significant portion of the systematic risk associated with the financial guarantees of variable annuities back to the capital markets on acceptable economic terms. The variable annuity hedging system 100 may reduce the long tail risk associated with variable annuities, dispersion of possible economic outcomes, and local capital requirements. Additionally, the variable annuity hedging system 100 may be scaled by adding or removing cores to provide a system to meet various hedging tasks associated with a wide range of financial products. Computation and analysis using the variable annuity hedging system 100 may proceed in a seriatim basis and results may be delivered to the users 110 in near real-time.

Using the system 100 and procedures described above, a user can calculate real-time synchronous asset and liability Greeks intraday as well as real-time seriatim valuation and risk monitoring for variable annuities and stochastic-on-stochastic calculations within a centralized user interface 700. Furthermore, because the system 100 may be offered to users as “software as a service” (SaaS), the system 100 may eliminate head count costs associated with the manual running and operation of tools and systems and, thus, produce reports in a reliable, accurate, and timely fashion.

The implementations described herein represent a technical solution to the technical problem of computing complex variable annuity hedging calculations in real time by efficiently utilizing processing resources of a computing grid. For example, the system 100 can calculate fifty thousand policy evaluations in real time via multiple processing resource paths such that each policy evaluation may be calculated on multiple GPUs based on available resources. By separating an incoming data stream for a policy evaluation into multiple data packets representing processing tasks to be executed by processing resources, the system 100 can distribute the processing tasks based on the available processing resources in order to maximize processing efficiency. The implementations described herein can also be applied to other technical fields that perform complex data manipulations such as other types of fields that deal with large amounts of statistical data including science and engineering as well as other types of financial fields.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

For example, the system 100 may include but is not limited to any combination of a LAN, a MAN, a WAN, a mobile, a wired or wireless network, a private network, or a virtual private network.

Additionally, certain embodiments are described herein as including logic or a number of components, modules, or mechanisms. Modules may constitute either software modules (e.g., code embodied on a machine-readable medium or in a transmission signal, wherein the code is executed by a processor) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may include dedicated circuitry or logic that is permanently configured (e.g., as a special-purpose processor, such as a field programmable gate array (FPGA) or an application-specific integrated circuit (ASIC)) to perform certain operations. A hardware module may also include programmable logic or circuitry (e.g., as encompassed within a general purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware implemented module” refers to a hardware module. Considering embodiments in which hardware modules are temporarily configured (e.g., programmed), each of the hardware modules need not be configured or instantiated at any one instance in time. For example, where the hardware modules include a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, include processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a SaaS. For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating.” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “includes,” “comprising.” “includes,” “including,” “has,” “having” or any other variation thereof, are intended to cover a non-exclusive inclusion. For example, a process, method, article, or apparatus that includes a list of elements is not necessarily limited to only those elements but may include other elements not expressly listed or inherent to such process, method, article, or apparatus. Further, unless expressly stated to the contrary. “or” refers to an inclusive or and not to an exclusive or. For example, a condition A or B is satisfied by any one of the following: A is true (or present) and B is false (or not present), A is false (or not present) and B is true (or present), and both A and B are true (or present).

Still further, the figures depict preferred embodiments of a map editor system for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for a system and a process for identifying terminal road segments through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

While certain embodiments have been described, these embodiments have been presented by way of example only, and are not intended to limit the scope of the present disclosures. Indeed, the novel methods, apparatuses and systems described herein can be embodied in a variety of other forms; furthermore, various omissions, substitutions and changes in the form of the methods, apparatuses and systems described herein can be made without departing from the spirit of the present disclosures. The accompanying claims and their equivalents are intended to cover such forms or modifications as would fall within the scope and spirit of the present disclosures.

What is claimed is:

1. A system for managing processing resources of a computing grid to coordinate calculation of operations supporting real-time or near real-time risk hedging decisions, the system comprising:
a data input interface configured to
receive, from one or more external sources, a real-time data stream including i) one or more real-time financial market data streams, and ii) one or more trade updates corresponding to a user, and
transform the received data stream into a data structure format compatible with one or more computing resources; and
a computing grid including a plurality of computing cores, each core including a computer-readable memory storing computer-executable functions thereon that, when executed by each of the plurality of computing cores, cause the plurality of computing cores to calculate computation results for one or more allocated processing tasks associated with the received data stream, wherein the computation results comprise variable annuity calculation results;
a task manager server including a computer-readable memory storing computer-executable functions thereon that, when executed by processing circuitry of the task managing server, cause the task managing server to
divide the transformed data stream into a plurality of processing tasks to be executed by the plurality of computing cores,
control allocation and deallocation of the plurality of processing tasks to the plurality of computing cores,
aggregate the computation results for the plurality of processing tasks into an output array representing evaluation results for the received data stream; and
a web server including a computer-readable memory storing computer-executable functions thereon that, when executed by processing circuitry of the web server, cause the web server to generate, from the computation result, a seriatim intraday report illustrating effect on an intraday risk position based upon the one or more trade updates as evidenced by the evaluation results.

2. The system of claim 1, further comprising a computing core managing server including a computer-readable memory storing computer-executable functions thereon that, when executed by processing circuitry of the computing core managing server, cause the computing core managing server to allocate, in response to receiving an allocation command from the task managing server, the plurality of processing tasks between the plurality of computing cores.

3. The system of claim 2, wherein the computer-executable functions, when executed by the processing circuitry of the task managing server, cause the task managing server to:
establish, in response to receiving the transformed data stream from the data input interface, a first communication link with the computing core managing server; and
initiate, in response to establishing the communication link with the computing core managing server, a data stream processing session with the computing core managing server, wherein the data stream processing session includes allocation commands for execution of the plurality of processing tasks by the plurality of computing cores.

4. The system of claim 3, wherein controlling the allocation and deallocation of the plurality of processing tasks to the plurality of computing cores includes establishing, in response to receiving a session initiation acknowledgement message from the computing core managing server identifying one or more allocated computing cores, a second communication link with the one or more allocated computing cores.

5. The system of claim 4, wherein controlling the allocation and deallocation of the plurality of processing tasks to the plurality of computing cores includes transmitting one or more of the plurality of processing tasks to the one or more allocated computing cores via the second communication link.

6. The system of claim 1, wherein the plurality of processing tasks each include a plurality of computer-executable steps corresponding to a particular function of a set of functions for performing a Monte Carlo simulation.

7. The system of claim 1, wherein controlling the allocation and deallocation of the plurality of processing tasks to the plurality of computing cores includes updating an in-flight task list identifying processing task assignments for one or more allocated computing cores of the plurality of computing cores.

8. The system of claim 7, wherein controlling the allocation and deallocation of the plurality of processing tasks to the plurality of computing cores includes, in response to establishing a reconnection to the one or more allocated computing cores after an unexpected disconnection, retransmitting the processing task assignments to the one or more allocated computing cores indicated on the in-flight task list.

9. The system of claim 1, wherein controlling the allocation and deallocation of the plurality of processing tasks to the plurality of computing cores includes balancing assignment of the plurality of processing tasks among the plurality of computing cores based on at least one of a priority associated with each of the plurality of processing tasks and a number of the plurality of computing cores.

10. The system of claim 1, wherein the plurality of computing cores include at least one of cloud-based processing resources and non-cloud-based processing resources.

11. The system of claim 10, wherein controlling the allocation and deallocation of the plurality of processing tasks to the plurality of computing cores includes balancing assignment of the plurality of processing tasks among the plurality of computing cores based on network connectivity conditions for communication links between the cloud-based processing resources and non-cloud-based processing resources.

12. The system of claim 1, wherein controlling the allocation and deallocation of the plurality of processing tasks to the plurality of computing cores includes simultaneously assigning one or more of the plurality of processing tasks to one or more allocated computing cores in parallel with receiving computation results for previously assigned processing tasks from one or more previously allocated computing cores.

13. The system of claim 1, wherein controlling the allocation and deallocation of the plurality of processing tasks to the plurality of computing cores includes transmitting status messages to one or more allocated computing cores at predetermined time intervals.

14. The system of claim 13, wherein controlling the allocation and deallocation of the plurality of processing tasks to the plurality of computing cores includes, when detecting that an allocated computing core is unresponsive:
flagging the allocated computing core as unavailable for processing task assignment; and
reassigning at least one assigned processing task from the unresponsive computing core to a computing core that is available for processing task assignment.

15. The system of claim 1, wherein aggregating the computation results for the plurality of processing tasks includes issuing aggregation commands to one or more allocated computing cores at predetermined checkpoints associated with interrelated computation results calculated by different computing cores.

16. The system of claim 15, wherein aggregating the computation results for the plurality of processing tasks includes, in response to receiving the interrelated computation results from the different computing cores, calculating aggregated computation results from the interrelated computation results.

17. A method comprising:
transforming, at a data input interface for a computing grid, a received data stream into a data structure format compatible with computing resources of the computing grid, wherein the received data stream comprises i) one or more real-time financial market data streams, and ii) one or more trade updates corresponding to a user;
dividing, at a task managing server of the computing grid, the transformed data stream into a plurality of processing tasks to be executed by the computing resources including a plurality of computing cores, wherein each of the plurality of processing tasks comprises a plurality of computer-executable steps corresponding to a particular function of a set of functions describing variable annuity risk;
controlling, at the task managing server, allocation and deallocation of the plurality of processing tasks to the plurality of computing cores;
calculating, at each of the plurality of computing cores, computation results for one or more allocated processing tasks associated with the received data stream;
aggregating, at the task managing server, the computation results for the plurality of processing tasks received from the plurality of computing cores;
identifying, based on the evaluation results, breach of at least one risk limit; and
preparing, for review at a display interface of a remote computing device, a graphical user interface presenting information regarding the breach of the at least one risk limit.

18. The method of claim 17, further comprising accessing a hedging model, wherein the hedging model comprises the set of functions describing variable annuity risk.

19. A non-transitory computer readable medium having instructions stored thereon, wherein the instructions, when executed by processing circuitry, cause the processing circuitry to:
receive, in real-time from at least one remote computing system, market data and trade data;
divide computer-executable steps corresponding to a set of functions for calculating investment risk into a plurality of processing tasks for allocation to computing resources of a computing grid including a plurality of computing cores;
divide the market data and the trade data into data sets, each data set corresponding with at least one processing task of the plurality of processing tasks;
control allocation and deallocation of the plurality of processing tasks and associated data sets the plurality of computing cores;
aggregate computation results for the plurality of processing tasks received from the plurality of computing cores into an output array representing evaluation results for the received market data and trade data; and
combine, in a report for display at a remote computing device; information representing the aggregate computation results in comparison with prior aggregate computation results calculated for a prior timeframe.

20. The non-transitory computer readable medium of claim 19, wherein the instructions, when executed by processing circuitry, cause the processing circuitry to, prior to dividing the market data and the trade data, transform a trade data stream and a market data stream into a data structure format compatible with the computing resources of the computing grid.
